(19) United States
(12) Patent Application Publication
(10) Pub. No.: US 2003/0152292 A1
(43) Pub. Date: Aug. 14, 2003

(54) SYSTEM, METHOD, AND APPARATUS FOR SATELLITE REMOTE SENSING

(76) Inventors: Walter S. Scott, Boulder, CO (US); Gregory E. Knoblauch, Aurora, CO (US); Gerald M. Chicoine, Longmont, CO (US); James G. McClelland, Longmont, CO (US); Paul W. Scott, Louisville, CO (US); Jack F. Paris, Longmont, CO (US)

(21) Appl. No.: 10/248,091

(22) Filed: Dec. 17, 2002

Related U.S. Application Data
(60) Provisional application No. 60/341,722, filed on Dec. 17, 2001.

(51) Int. Cl. G06K 9/32; G06K 9/40; G06K 9/54; G06K 9/60

(52) U.S. Cl. 382/298; 382/260; 382/302

(57) ABSTRACT

### Abstract of Disclosure

A system, method, and apparatus for remote sensing is disclosed. The system method, and apparatus can capture raw image data from outer space at a first resolution and provide multiple resolution images from this raw image data without requiring multiple-resolution image data to be captured. The raw image data is utilized to provide both a high resolution image directly from the data and also aggregates the raw image data to provide a lower resolution image. The system, method, and apparatus can further utilize a red edge band of the near infrared band for remote sensing.

### Cross Reference to Related Applications

This application claims the benefit of United States Provisional Application No. 60/341,722, entitled SATELLITE CONSTELLATION AND METHOD FOR USING INFORMATION PRODUCED BY THE SATELLITE CONSTELLATION and filed by Walter S. Scott et al. on December 17, 2001, which application is incorporated by reference into this application in its entirety.

### Field of the Invention

This invention relates to remote sensing satellite imaging, and more particularly to aggregating raw image data from a remote sensing satellite to provide lower resolution image data.

### Background of the Invention

Landsat and other remote sensing satellites currently provide relatively low-resolution image detection from space. These images are commonly used for agricultural and other purposes for monitoring large areas. Often, however, the resolution of these images is inadequate. In these situations, a completely independent satellite system must be utilized to provide a higher-resolution image.

### Summary of the Invention

The present invention provides a system, method, and apparatus for remote sensing that captures raw image data from outer space at a first resolution and is adapted to provide multiple resolution images from this raw image data without requiring multiple-resolution image data to be captured. The present invention utilizes the raw image data to provide both a high resolution image directly from the data and also aggregates the raw image data to provide a lower resolution image.

The present invention further provides a system, method, and apparatus for remote sensing utilizing a red edge band of the near infrared band for remote sensing from outer space.

### Brief Description of the Drawings

The preferred embodiments of the invention will be described in detail with reference to the following figures, wherein like numerals refer to like elements, and wherein:

Figure 1 depicts a satellite in orbit around the Earth;

Figure 2 depicts a constellation of satellites flying in formation in orbit around the Earth;

Figure 3 depicts a block diagram of a satellite remote sensing system for collecting and transmitting image data;

Figure 4 depicts a block diagram of multiple resolution images being calculated from raw data captured at a single resolution;

Figure 5 depicts a system for processing image data on-board a remote sensing satellite in which data aggregation is performed on-board the satellite; and

Figure 6 depicts a system for receiving a satellite transmission and processing the signal to aggregate image data.

### Detailed Description

Each of the figures described below depict exemplary embodiments. None of these figures are intended to be limiting, but rather provide differing examples of embodiments that may be used within the scope of the present invention as defined below in the claims.

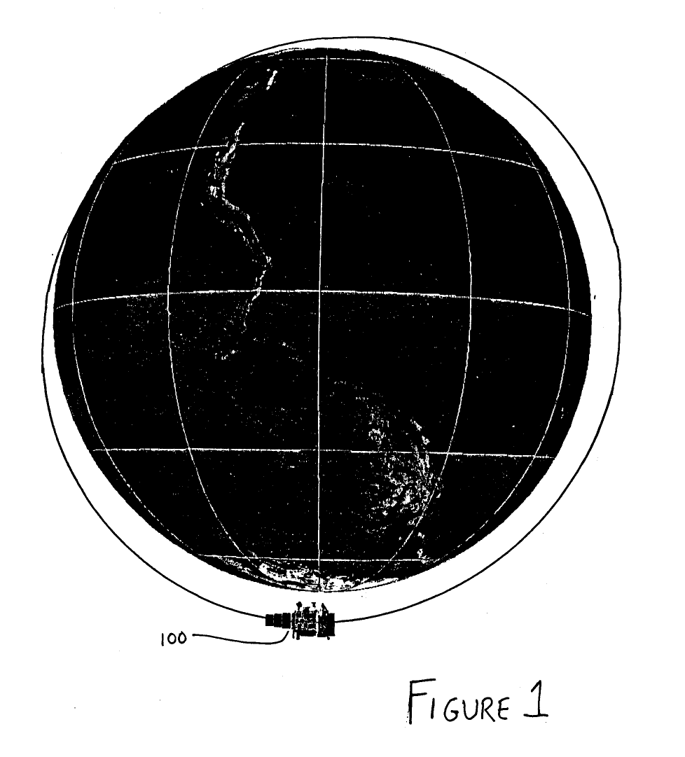

Figure 1 depicts a satellite 100 in orbit around the earth. The satellite, in one exemplary embodiment, maintains a precision-controlled sun-synchronous, near-polar, Worldwide Reference System-2 (WRS-2) orbit at a nominal altitude of 705 kilometers, which provides a ground track suite of 233 orbits and repeats every sixteen days. The satellite preferably captures at least a 185 kilometer wide swath and maintains its orbit within ± 5 kilometers of the WRS-2 nadir track. The satellite may include various types of remote sensing equipment as is known in the art. For example, the satellite may includes a wide pushbroom array scanner that utilizes time delay and integration (TDI) to increase the signal to noise ratio (SNR) of the raw image data.

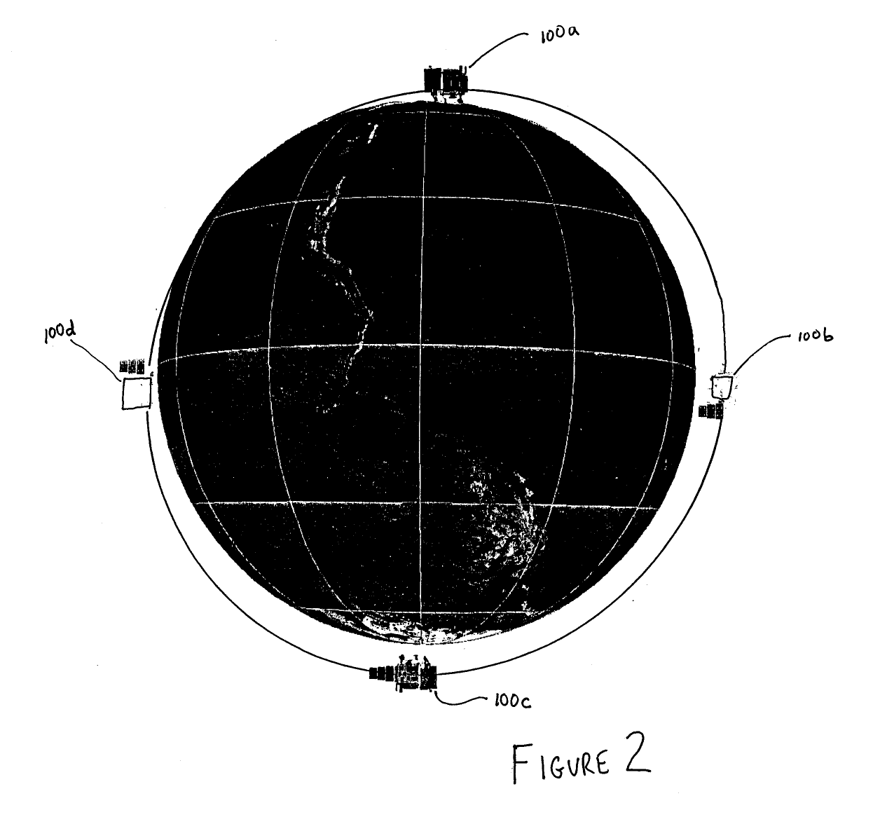

Figure 2 depicts an exemplary constellation of four satellites 100 flying in formation in orbit around the earth. Each satellite 100 is separated by nominally 90 degrees from the adjacent satellites. For example, when the first satellite 100a is located at 0 degrees, the second, third, and fourth satellites 100b, 100c, and 100d are located at 90, 180, and 270 degrees, respectively. In one embodiment, for example, after the first satellite is launched, a second satellite may be launched into orbit 180 degrees apart from the first satellite, followed by third and fourth satellites launched simultaneously at 90 degrees and 270 degrees apart from the first satellite. If each satellite repeats its orbit every 16 days, a constellation of four satellites flying in formation, such as shown in Figure 2, provides a repeat every four days. Alternatively, the constellation may have any other number of satellites to provide a particular repeat coverage. A constellation of two satellites, for example, would provide a repeat every eight days, and a constellation of eight satellites would provide a repeat of every two days.

The repeat duration of a particular satellite or constellation of satellites may also be altered by adjusting the time it takes each satellite to complete its orbit. For example, if each satellite repeats its orbit every 8 days instead of every 16 days, each satellite or constellation of satellites would provide a repeat twice as often.

Repeat coverage of particular targets may also be increased by altering the view of the satellite remote sensing system, such as by rolling the satellite. In this way, a satellite may be rolled to capture an image of a swath to the left of the satellite, to the right of the satellite, or directly underneath the satellite. If cloud cover prevented the satellite from capturing a desired quality image on one pass, for example, the satellite may be rolled from an adjacent track to capture the image.

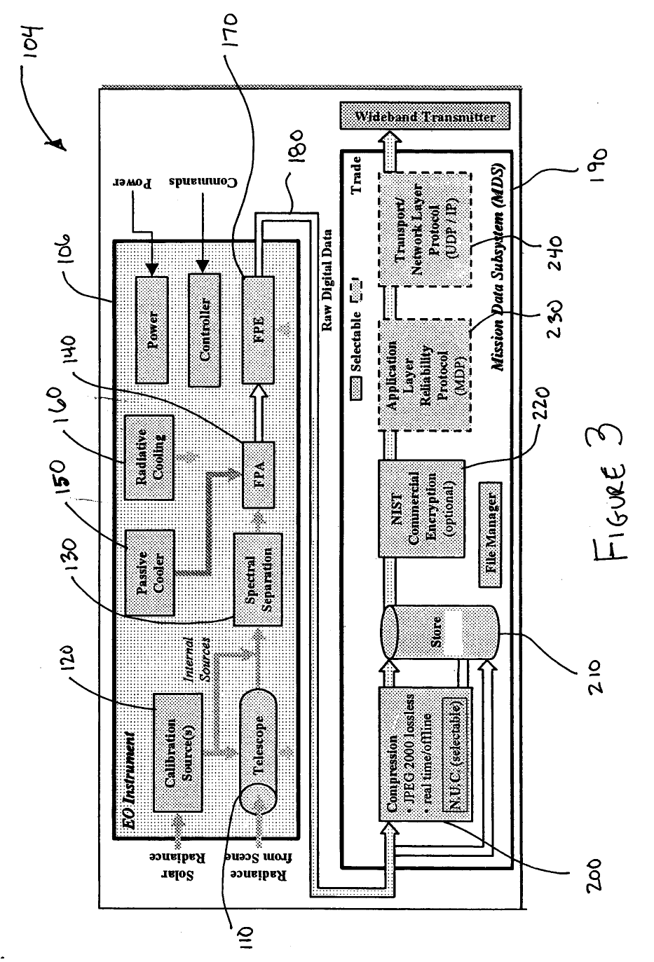

Figure 3 depicts an exemplary block diagram of an image chain104 that may reside on a remote sensing satellite to capture data at a first resolution via telescope 110. The telescope 110 is calibrated utilizing calibration source 120 as is known in the art. The captured radiance undergoes spectral separation in block 130 and is forwarded to a focal plane assembly (FPA) in block 140, in which the radiance is converted into digital signals. The instrument 106, including the FPA 140, is cooled by a passive cooler 150 and a radiative cooler 160. From block 140, the data is forwarded to a focal plane electronics (FPE) block 170 in which the data is corrected, including nonuniformity correction as needed. The raw digital data is then transmitted via bus 180 to the mission data subsystem 190. The raw digital data can be compressed in block 200, such as using a JPEG2000 loss-less algorithm. The compression may be performed in real time or off-line. The data is stored in data storage device 210 until the data is to be transmitted from the satellite. The data may also be encrypted in block 220 for transmission, such as using a National Institute of Standards and Technology (NIST) commercial encryption. The data may be compressed and/or encrypted before or after the data is stored on data storage device 210. The data may also optionally be provided to an application layer reliability protocol in block 230 and/or a transport/network layer protocol in block 240, such as a User Datagram Protocol/Internet Protocol (UDP/IP) for transmission from the satellite.

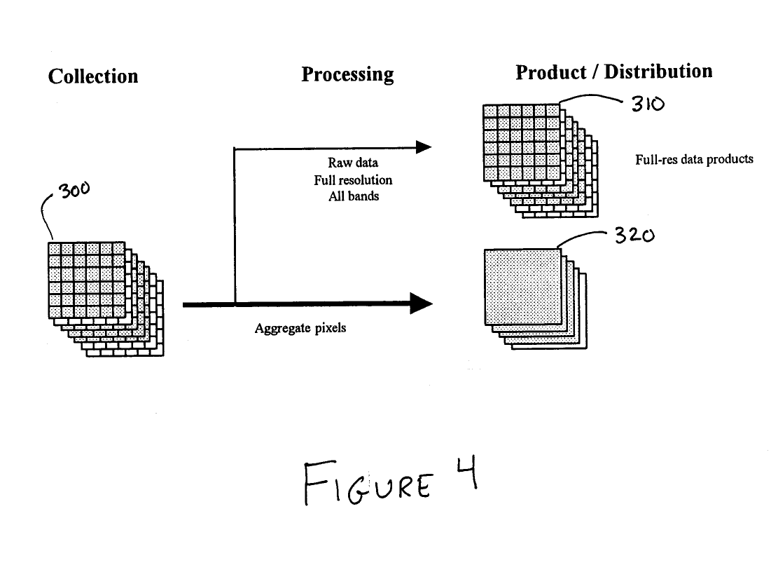

Figure 4 shows data 300 collected at a first resolution and images that are created from the collected data. The first group of images 310 includes full-resolution images having the resolution of the collected data 300. The second group of images 320 includes partial-resolution images created by aggregating the collected data 300 to create second resolution images. "Aggregated" data is defined for the purpose of the present invention as combining multiple data points to create a single data point that is representative of the multiple data points. The data points may be combined, for example, by a simple summing algorithm or a weighted sum algorithm as described below.

The collected data, for example, may be collected at a first resolution that is a factor of the second resolution. Each pixel of the second resolution image may be calculated, for example, by aggregating the pixel values of the collected data 300 in the following summing algorithm:

$${Y}_{i , j} = {\sum }_{n = 0}^{a - 1} {\sum }_{m = 0}^{b - 1} {X}_{a \cdot i + n , b \cdot j + m}$$

wherein X represents the collected resolution image pixel values, Y represents the aggregated pixel values of the second resolution image, and a and b represent the dimensions of a block of pixels being aggregated to calculate an aggregated pixel value for a particular Y_{i,j}. The calculation of the aggregated pixel values Y can be shown by a first exemplary system in which the data is collected at a 5 meter resolution and used to provide a 5 meter first resolution image 310 and a 30 meter second resolution image 320, e.g., a Landsat Data Continuity Mission (LDCM) image. In this system, for example, each of the aggregated pixel values Y_{i,j} of the second resolution image can be calculated by summing a six by six block of pixel values of the collected data 300, i.e., a = 6 and b = 6. If the data 300 is collected at a 7.5 meter resolution, however, the aggregated pixel values Y of a second resolution image having a 30 meter resolution are calculated by summing a four by four block of pixel values of the collected data, i.e., a = 4 and b=4. Other variations of collected data resolutions and aggregated image resolutions can also be used.

The aggregated pixel values of the second resolution image may be calculated using a number of alternative down-sampling kernels, such as the following weighted sum algorithm:

$${Y}_{i , j} = {\sum }_{n = 0}^{c - 1} {\sum }_{m = 0}^{d - 1} {Z}_{n , m} \cdot {X}_{a \cdot i + n , b \cdot j + m}$$

wherein X represents the collected resolution image pixel values, Y represents the aggregated pixel values of the second resolution image, Z represents a weighting kernel, where c and d are arbitrary positive integers representing the kernel dimensions, and a and b represent the dimensions of the aggregated pixel, Y_{i,j}. In one embodiment, for example, the aggregated pixels can be an average where Z_{n,m} remains constant at the value of the inverse of the product of c and d, i.e., 1 / (c · d). Alternatively, the aggregated pixels can simply be the value of a single pixel from the collected data where Z_{n,m} is equal to zero, except for one combination of n,m. Weighting factors may also be used, for example, to reduce aliasing, minimize modulation transfer function (MTF) reduction in the pass-band, or compensate for inoperable pixels, such as to exclude an inoperable pixel from an aggregated pixel or calibrate and include the inoperable pixel in the aggregated pixel with a reduced weight. Other variations of weighting factors known in the art may also be used.

Aggregating the pixel values of a high-resolution image may be performed to provide a lower resolution image for any number of purposes. Various resolution images, for example, may be provided depending upon the particular needs of a customer. Alternatively, lower resolution image data may also be transmitted prior to the transmission of higher resolution image data in order to allow for quality control inspections or calculations to be performed before the high-resolution image data is transmitted. Where the image is unsatisfactory, e.g., a satellite image largely blocked by cloud cover, the image may be rejected before the high-resolution image is transmitted to conserve transmission bandwidth.

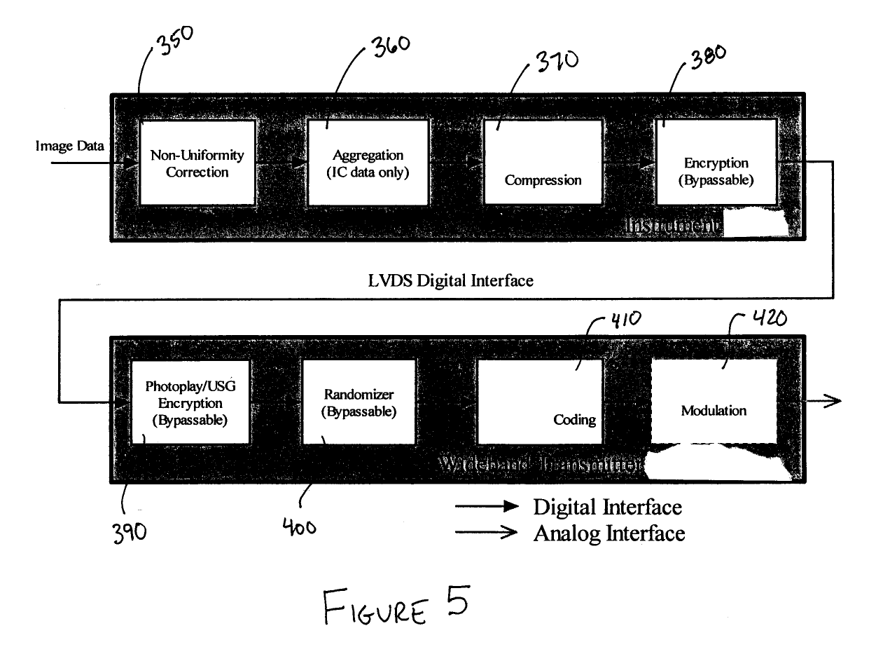

Figure 5 depicts an exemplary block diagram of a portion of a satellite in which the data aggregation is performed on-board the satellite. In this embodiment, the raw image data is received at block 350 and undergoes non-uniformity correction, as is known in the art. The data then aggregated in block 360, such as via a summing algorithm or weighted sum algorithm as described above. The aggregated data is then received at block 370 for compression, such as via a JPEG2000 loss-less compression algorithm. The data may also be encrypted, such as via AES commercial encryption and/or Photoplay/United States Government encryption as shown in blocks 380 and 390, respectively. By passable randomizer block 400 also allows the data to be optionally randomized. The data may also be optionally coded in block 410. The coding performed in block 410, for example, may include error correction coding or other types of coding known in the art. The data is then modulated for transmission, such as via offset quaternary phase shift keying (O-QPSK) modulation, as shown in block 420.

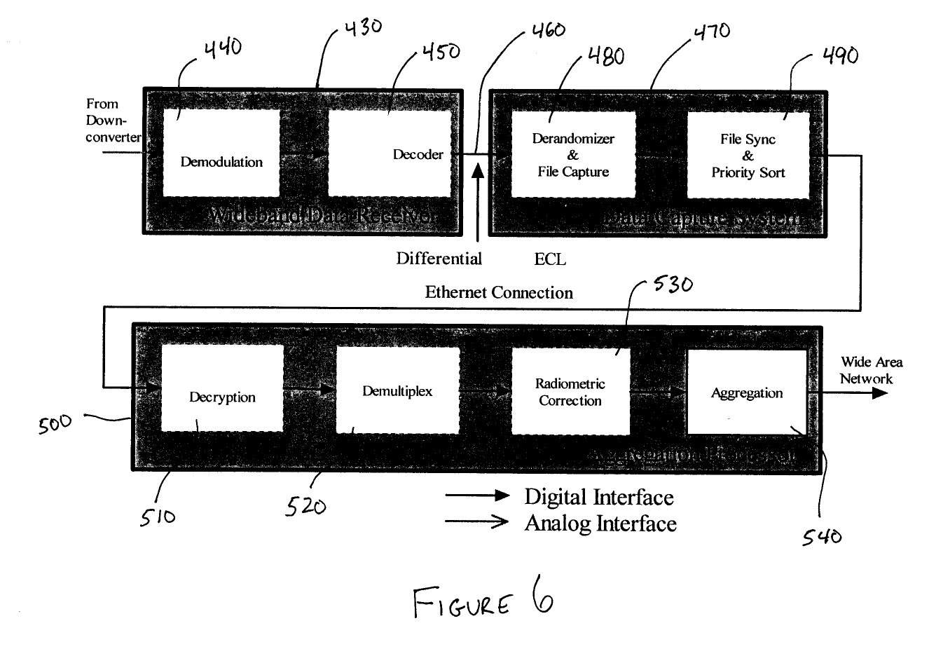

Figure 6 depicts an exemplary block diagram of an another embodiment in which the data is aggregated downstream of the satellite, such as at a remote ground terminal or at a mission control center. In this embodiment, the data is received in a wideband data receiver 430. The data is demodulated in block 440, such as utilizing an offset quaternary phase shift keying (O-QPSK) demodulator. The demodulated data is decoded in block 450 and transmitted through a differential emitter coupled logic (ECL) 460 to the data capture system 470 in which the data is derandomized and captured in block 480 and synchronized and sorted in block 490. The data is transmitted to an aggregation processor 500, which decrypts the data in block 510, demultiplexes the data in block 520, and performs a radiometric correction in block 530. The data is aggregated in block 540, such as via a simple summing algorithm or weighted sum algorithm as described above.

As shown in Figures 5 and 6, the aggregation of the raw data may be performed on-board the satellite, or downstream of the satellite, e.g., on the ground. In one embodiment in which aggregation is performed on-board a satellite, however, the system may include a redundant aggregation capability on the ground so that if a transmission error occurs during the transmission of the aggregated data, the aggregated data may be recalculated on the ground.

The remote sensing system preferably includes multi-spectral focal-plane technology for capturing images in different spectra. A focal plane of a particular satellite may, for example, capture images in spectra such as the visible spectrum or the infrared spectrum, The visible spectrum is generally defined as having a wavelength in the range from about 400 nm to about 700nm and is divided into the blue, green, and red bands. The blue band is generally defined as having a wavelength of about 400 to 500 nm, while the green band extends from about 500 nm to about 600 nm, and the red band extends from about 600 nm to about 700 nm. The ultraviolet spectrum extends below the visible spectrum, i.e., has a wavelength of less than about 400 nm, and the infrared spectrum extends above the visible spectrum, i.e., has a wavelength above about 700 nm. The infrared spectrum includes the near infrared band (NIR), which is generally defined as having a wavelength from about 700 nm to about 1400 nm.

For the purposes of the present invention, the "red edge" band is defined as the portion of the near infrared band adjacent to the red band of the visible spectrum and is defined as having a wavelength from about 700 nm to about 760 nm. Because oxygen, which is a significant component of the Earth's atmosphere, absorbs light having a wavelength of about 760 nm, satellite imaging systems have avoided this portion of the near infrared band.

In agricultural imaging, for example, various spectra can be used to monitor different phenomena that can be used to monitor the growth and health of crops. In one exemplary embodiment, chlorophyll can be monitored in multiple spectra such as the blue, green, red, and red edge bands. Chlorophyll is a green pigment that resides within chloroplasts, which perform photosynthesis in plants, i.e., convert solar energy into chemical energy. As chloroplast and chlorophyll levels drop, the plants' ability to perform photosynthesis is reduced. Thus, detecting chlorophyll levels in a crop from a satellite provides an indicator of the health of the crop.

A strong absorption of chlorophyll occurs at approximately 668 nm, which is within the red band. Weaker absorption also occurs on either side and extends at least into the green, and blue bands at lower wavelengths and into the near infrared (NIR) band, including the red edge band, at higher wavelengths. At approximately 760 nm, however, the strong absorption of oxygen creates an interference with detecting anything on the Earth's surface. Examination of images taken through filters in the various bands can provide useful information to detecting the health of plants on the Earth's surface. Comparing changes of brightness detected in the blue, green, red, red edge, and near infrared bands, for example, can provide an indicator of changing chlorophyll levels in a particular crop that is being routinely monitored from outer space. Thus, monitoring multiple bands simultaneously and comparing data from the images created can be used to determine changes in chlorophyll levels.

In one exemplary embodiment, for example, the multi-spectral imaging may include a combination of bands to support applications using data collected by legacy space-based systems such as Landsat and SPOT. Additional bands may be included to provide unique image information from a space-based collection system, such as the red edge band. For example, an exemplary embodiment of a remote sensing system may include multi-spectral capabilities to capture images at bands such as, but not limited to, the bands listed in Table 1.

TABLE 1

| | | |
|---|---|---|
| | Lower λ | Upper λ |
| Band | (nm) | (nm) |

| | | | |
|---|---|---|---|
| 1 | Coastal | 433 | 453 |
| 2 | Blue | 450 | 515 |
| 3 | Green | 525 | 600 |
| 4 | Red | 630 | 680 |
| 5 | NIR | 845 | 885 |
| 6 | SWIR 1 | 1560 | 1660 |
| 7 | SWIR 2 | 2100 | 2300 |
| 8 | Sharpening | 500 | 680 |
| 8 | Sharpening | 630 | 680 |
| 9 | Cirrus | 1360 | 1390 |
| A | Gap Filler | 600 | 630 |
| B | Split Red | 660 | 690 |
| C | Red Edge | 700 | 730 |
| D | QB NIR | 760 | 860 |

While the invention has been described in conjunction with the specific embodiments outlined above, it is evident that many alternatives, modifications, and variations will be apparent to those skilled in the art. Accordingly, the preferred embodiments of the invention are intended to be illustrative and not limiting. Various changes may be made without departing from the spirit and scope of the invention as defined in the following claims.

Claims

1. A satellite image comprising a plurality of combined pixels each having a value calculated by aggregating a plurality of raw data pixel values of an image captured from outer space.

2. The satellite image of claim 1, wherein said value of each of said combined pixels was calculated by aggregating an s by t array of raw data pixel values in which s and t represent integers, and at least one of s and t is at least 2.

3. The satellite image of claim 1, wherein said aggregation was performed utilizing a simple sum algorithm.

4. The satellite image of claim 1, wherein said aggregation was performed utilizing a weighted sum algorithm.

5. A satellite imaging system comprising:
at least one satellite for capturing images from outer space, the satellite capturing images comprising a plurality of raw data pixels; and
a processor for aggregating values of said raw data pixels into combined pixel values to form an image.

6. The satellite imaging system of claim 5, wherein the processor is resident on the satellite and the combined pixel values are transmitted from the satellite.

7. The satellite imaging system of claim 5, wherein the satellite transmits the plurality of raw data pixel values to a computer housing the processor.

8. The satellite imaging system of claim 5, wherein the system comprises a plurality of satellites flying in formation.

9. The satellite imaging system of claim 8, wherein said plurality of satellites are flying 90 degrees apart.

10. The satellite imaging system of claim 5, wherein the satellite is flying in a precision-controlled WRS-2 orbit.

11. The satellite imaging system of claim 5, wherein the satellite is adapted to be rolled to change the view of a telescope.

12. A method of creating a satellite image comprising:
capturing a raw image from outer space comprising a plurality of raw data pixels;
calculating a plurality of combined pixel values by aggregating values of a subset of the plurality of raw data pixels for each of the plurality of combined pixel values; and
creating an image utilizing the plurality of combined pixel values.

13. The method of claim 12, wherein the raw image is captured using a time delay and integration scanning process.

14. The method of claim 12, wherein the raw image is captured utilizing a wide pushbroom array scanner.

15. A method for producing an image comprising:
receiving a first image of an area of the earth's surface, said first image comprised of a two-dimensional array of pixels and having a first resolution in which pixel is representative of a first defined portion of said area of the earth's surface, each pixel having a value;
processing said first image to produce a second image of at least a portion of said area that has a second resolution that is lower than said first resolution that pixel in said second image is representative of a second defined portion of said are of the earth's surface that is greater than said first defined portion.

16. The method of claim 15, wherein said step of processing comprises aggregating values associated with a plurality of pixels within said first image to produce a value of a pixel within said second image.

17. The method of claim 16, wherein said plurality of pixels are in an s by t array, where s and t are integers and at least one of s and t is at least 2.

18. The method of claim 16, wherein said values are weighted values.

19. The method of claim 15, wherein said step of receiving occurs on a satellite.

20. The method of claim 19, wherein said step of processing occurs on a satellite.

21. The method of claim 19, wherein said step of processing occurs at a first ground station that is capable of communicating with a satellite.

22. The method of claim 21, wherein said step of processing occurs at a second ground station that is different than sad first ground station.

23. The method of claim 15, wherein said step of receiving occurs at a first ground station that is capable of communicating with a satellite.

24. The method of claim 23, wherein said step of processing occurs at said first ground station.

25. The method of claim 23, wherein said step of processing occurs at a second ground station that is different than said first ground station.

26. A computer readable medium containing instructions for controlling a computer system to create a satellite image, by:
aggregating a first plurality of raw data pixel values captured from outer space to create a first combined pixel value; and
aggregating a second plurality of raw data pixel values captured from outer space to create a second combined pixel value.

27. The computer readable medium of claim 26, further comprising creating a satellite image utilizing the first combined pixel value and the second combined pixel value.

28. The computer readable medium of claim 26, wherein the computer readable medium is resident on a remote sensing satellite.

29. The computer readable medium of claim 26, wherein the computer readable medium is resident downstream of a remote sensing satellite.

30. A computer readable medium containing a data structure for representing a satellite image captured in outer space comprising:
a first plurality of raw data pixel values captured from outer space;
a second plurality of raw data pixel values captured from outer space;
a first combined pixel value that was calculated by aggregating the first plurality of raw data pixel values; and
a second combined pixel value that was calculated by aggregating the second plurality of raw data pixel values.

31. The computer readable medium of claim 30, wherein the computer readable medium is resident on a remote sensing satellite.

32. The computer readable medium of claim 30, wherein the computer readable medium is resident downstream of a remote sensing satellite.

33. A computer readable medium containing a data structure for representing a satellite image captured in outer space comprising:
a raw data table containing an entry for each of a plurality of raw data pixel values captured from outer space; and
a combined data table containing an entry for each of a plurality of combined pixel values, wherein each of the combined pixel values was calculated by aggregating a subset of the plurality of the raw data pixel values of the raw data table.

34. The computer readable medium of claim 33, wherein each subset utilized to calculate the combined pixels is mutually exclusive.

35. A computer data signal embodied in a transmission medium comprising a plurality of combined pixel values that were calculated by aggregating a plurality of raw data pixel values captured in outer space.

36. A satellite image comprising a plurality of pixels captured from outer space through a red edge band spectral filter.

37. A method for determining the health of a crop comprising:
comparing a first data set and a second data set, said first data set being derived from a first image taken from a first satellite of an area of the Earth's surface through a first red band spectral filter at a first time, said second data set being derived from a second image taken from a second satellite of said area through a second red band spectral filter at a second time distinct from said first time;
comparing a third data set and a fourth data set, said third data set being derived from a third image taken from said first satellite of said area through a first red edge band spectral filter at said first time, said fourth data set being derived from a fourth image taken from said second satellite of said area through a second red edge band spectral filter at said second time;
determining a change in chlorophyll presence in said area from said first time to said second time.

38. The method of claim 37, wherein the first satellite and the second satellite are different satellites.

39. A satellite comprising:
a remote sensor having a red spectral band filter and a red edge band spectral filter, said remote sensing device being adapted to capture a first image through said red band spectral filter and a second image through said red edge band spectral filter;
a processor adapted to convert said first image into a first data set and said second image into a second data set.

40. The satellite of claim 39, further comprising a data storage device, wherein said processor stores said first data set and said second data set in said data storage device.

41. The satellite of claim 40, wherein said processor is further adapted to compare said first data set with a third data set converted from a third image captured through said red band spectral filter, to compare said second data set with a fourth data set converted from a fourth image captured through said red edge band spectral filter, and to determine a change in chlorophyll presence from the first and second images to the third and fourth images.

42. The satellite of claim 39, further comprising a transmitter adapted to transmit said first data set and said second data set.

43. The satellite image of claim 36, wherein the red edge band spectral filter is in the range from about 700 nm to about 730 nm.

44. The satellite image of claim 36, wherein the red edge band spectral filter is in the range from about 715 nm to about 745 nm.

45. The satellite image of claim 36, wherein the red edge band spectral filter is in the range from about 700 nm to about 750 nm.

46. A computer readable medium containing instructions for controlling a computer to determine a change in chlorophyll level, by:
comparing a first data set and a second data set, said first data set and said second data set being derived from a first image and a second image respectively, said first and second images being taken from outer space of an area of the Earth's surface through a first red band spectral filter at a first time and a second time, respectively;
comparing a third data set and a fourth data set, said third data set and said fourth data set being derived from said first image and said second image respectively;
determining a change in chlorophyll presence in said area from said first time to said second time.

47. A computer signal embodied in a transmission medium comprising a change in chlorophyll presence calculated by:
comparing a first data set and a second data set, said first data set and said second data set being derived from a first image and a second image respectively, said first and second images being taken from outer space of an area of the Earth's surface through a first red band spectral filter at a first time and a second time, respectively;
comparing a third data set and a fourth data set, said third data set and said fourth data set being derived from said first image and said second image respectively;
determining a change in chlorophyll presence in said area from said first time to said second time.
